(19) United States
(12) Patent Application Publication
(10) Pub. No.: US 2020/0027636 A1
(43) Pub. Date: Jan. 23, 2020

(54) SOLENOID AND METHOD FOR MANUFACTURING SAME

(71) Applicant: TDS CO. LTD, Okaya-shi, Nagano (JP)

(72) Inventors: Chihiro KOBAYASHI, Okaya-shi (JP); Naoya MIYAZAWA, Okaya-shi (JP); Toshihiko MURASE, Okaya-shi (JP)

(73) Assignee: TDS CO. LTD, Okaya-shi, Nagano (JP)

(21) Appl. No.: 16/496,331

(22) PCT Filed: Mar. 23, 2017
(86) PCT No.: PCT/JP2017/011691

§ 371 Date: Sep. 20, 2019

(51) Int. Cl. H01F 7/14; F15B 13/043; F16K 31/06; H01F 7/08; H01F 5/02

(52) U.S. Cl. CPC H01F 7/14; F15B 13/0438; F16K 31/06; H01F 2007/086; H01F 5/02; H01F 2007/083; H01F 7/081

(57) ABSTRACT

[Object] To provide a solenoid with which, when attaching an iron core to a yoke, the iron core can be easily and firmly attached using an inexpensive, small, and general-purpose hand tool without crimping the iron core using a large press machine.

[Solution] A solenoid of the present invention is configured to include a yoke having a U-shaped cross section, a bobbin having an electromagnetic coil disposed inside the yoke, a fixed iron core disposed inside the bobbin, and a flapper attached to the yoke to be able to swing freely. The fixed iron core and a bottom surface of the yoke are integrally coupled by threaded fitting. Thus, the fixed iron core can be easily attached to the bottom surface of the yoke using a general-purpose, inexpensive, and small hand tool (a hand drill or an electric driver) without requiring a large workplace for crimping the fixed iron core as in the related art.

### TECHNICAL FIELD

The present invention relates to a solenoid used in OA apparatus, such as a copying machine, a facsimile machine, a hard disk, and the like, and various other information office apparatus.

More specifically, the present invention relates to a flapper-type solenoid, with which, when attaching an iron core (a fixed iron core) to a yoke, the core can be easily and firmly attached to the yoke using an inexpensive, small, and general-purpose hand tool without crimping the iron core using a large press machine, and also to a method for manufacturing the flapper-type solenoid.

### BACKGROUND ART

For example, the flapper-type solenoid is employed when positioning paper in a copying machine, a printer, and the like.

In the flapper-type solenoid, an electromagnet is configured by an iron core (a fixed iron core) provided in a center portion of a bobbin disposed inside a yoke, and an electromagnetic coil wound around the outer side of the bobbin. The flapper-type solenoid is operated as a result of energizing the electromagnetic coil to generate a magnetic field and attracting a movable plate (a flapper) that is disposed above the iron core to be able to swing freely.

An example of such a flapper-type solenoid is disclosed in Patent Document 1.

In JP 2000-124028 A (Patent Document 1), a flapper-type electromagnetic solenoid is proposed that includes an electromagnetic coil, a magnetic core positioned substantially at the center of the electromagnetic coil, and a rotatable flapper that is attracted to the magnetic core when a magnetic field is generated in an electromagnet configured by the electromagnetic coil and the magnetic core, and an urging member that separates the flapper from the magnetic core when the magnetic field of the electromagnet is removed. The flapper-type electromagnetic solenoid is characterized by interposing a sound-absorbing damping member between the flapper and a support portion supporting the flapper to absorb a banging sound at the time of operation, which is caused by rattling between mutual components.

Although this flapper-type solenoid is capable of maintaining a stable operation by suppressing the occurrence of rattling, noise, and vibration, an iron core, which is the magnetic core, is held and fixed to a frame by crimping means.

### CITATION LIST

### Patent Literature

Patent Document 1: JP 2000-124028 A (Claims, Paragraph 0043, and FIG. 8)

### DISCLOSURE OF THE INVENTION

### Technical Problem

In manufacturing a conventional flapper-type solenoid, such as the flapper-type electromagnetic solenoid disclosed in Patent Document 1, when attaching an iron core (a fixed iron core) to a yoke, typically, after inserting a bobbin, around which a coil is wound, into the yoke, the iron core is inserted into the bobbin and fixed to a bottom surface of the yoke by crimping means. Therefore, large and expensive press equipment and a large workspace are required.

Furthermore, there are problems in that it is inevitably difficult to reduce the production costs of the solenoid because the crimping operation requires a skilled operator, for example, and in that solenoids with quality issues, such as deformation of the yoke and insufficient crimping, may be produced because it is difficult to perform the crimping operation in a stable manner.

In light of the foregoing, an object of the present invention is to provide a flapper-type solenoid that can firmly fix an iron core using a small, inexpensive, and general-purpose hand tool (a hand drill or an electric driver) without using a large high spin press machine, and that can be easily assembled only by inserting components and tightening screws, and to provide a method for manufacturing the flapper-type solenoid.

### Solution to Problem

To achieve the above-described object, an aspect of the present invention described in claim 1 is a solenoid that includes a yoke having a U-shaped cross section, a bobbin having an electromagnetic coil disposed inside the yoke, a fixed iron core disposed inside the bobbin, and a flapper attached to the yoke to be able to swing freely. The fixed iron core and a bottom surface of the yoke are integrally coupled by threaded fitting.

In the solenoid described in claim 1, according to an aspect of the present invention described in claim 2, a thread groove of at least one of an external thread and an internal threaded fitted together by the threaded fitting includes an adhesive layer on a surface thereof.

In the solenoid described in claim 2, according to an aspect of the present invention described in claim 3, the adhesive layer is configured by a microcapsule encapsulating an adhesive component.

In the solenoid described in claim 2, according to an aspect of the present invention described in claim 4, the adhesive layer is configured by at least one of an epoxy resin-based adhesive and an acrylic resin-based adhesive.

In the solenoid described in claim 1, according to an aspect of the present invention described in claim 5, the fixed iron core has an external thread portion on a bottom portion thereof, and the bottom surface of the yoke has an internal thread portion that is constituted by a through hole having an inner circumferential surface formed with an internal thread, such that the internal thread portion screws together with the external thread portion.

In the solenoid described in claim 1, according to an aspect of the present invention described in claim 6, the bottom surface of the yoke has an external thread portion that is formed protruding toward the inside, and the fixed iron core has, on a tip end surface thereof, an internal thread portion that is constituted by a screw hole of a required depth having an inner circumferential surface formed with an internal thread, such that the internal thread portion screws together with the external thread portion.

In the solenoid described in claim 1, according to an aspect of the present invention described in claim 7, an internal thread portion is formed by communicating a through hole formed in the bottom surface of the yoke and having an internal thread on an inner circumferential surface thereof, and a screw hole of a required depth formed at a tip end surface of the fixed iron core, and having an internal thread on an inner circumferential surface thereof, with each other. The bottom surface of the yoke and the fixed iron core are integrally coupled by a rod-like external thread member having an external thread that is formed extending from a tip end toward a base end portion of an outer circumferential surface of the thread member such that the thread member screws together with the internal thread portion.

In the solenoid described in any one of claims 5 to 7, according to an aspect of the present invention described in claim 8, the external thread portion includes no less than three threads.

In the solenoid described in any one of claims 1 to 8, according to an aspect of the present invention described in claim 9, the flapper is pivotally supported by a vertical flange formed on one of raised portions of the yoke, and the flapper is configured to be able to swing freely by a spring member being attached between the yoke and the flapper.

In the solenoid described in claim 5 or 7, according to an aspect of the present invention described in claim 10, the through hole includes an annular portion formed protruding at a required height around an opening peripheral edge portion on the outer surface side of the through hole.

An aspect of the present invention described in claim 11 is a method for manufacturing a flapper-type solenoid. The method contains, inserting a fixed iron core into a bobbin, after installing the bobbin including an electromagnetic coil inside a yoke having a U-shaped cross section, and causing the fixed iron core threaded fitting with a bottom surface of the yoke.

### Advantageous Effects of Invention

A solenoid of the present invention is configured by including a yoke having a U-shaped cross section, a bobbin including an electromagnetic coil disposed inside the yoke, a fixed iron core disposed inside the bobbin; and a flapper attached to the yoke to be able to swing freely. The fixed iron core and a bottom surface of the yoke are integrally coupled by threaded fitting.

Thus, when attaching the fixed iron core to the bottom surface of the yoke, the attachment can be easily performed using a general-purpose, inexpensive, and small hand tool (a hand drill or electric driver) without requiring a large workplace for crimping the fixed iron core as in the prior art. Therefore, this solenoid can be easily assembled only by inserting components and tightening screws.

Furthermore, by forming an adhesive layer on a surface of a thread groove provided on at least one of an external thread or an internal thread in the fixed iron core or the bottom surface of the yoke, at the time of the threaded fitting, the fixed iron core can be more firmly fitted to the bottom surface of the yoke.

Meanwhile, in a method for manufacturing the solenoid of the present invention, after installing a bobbin including an electromagnetic coil inside a yoke having a U-shaped cross section, a fixed iron core is inserted into the bobbin and threaded fitted together with a bottom surface of the yoke. Thus, an effect equal to or greater than crimping means of the prior art can be imparted to the solenoid, and the solenoid can be assembled using a general-purpose, inexpensive, and small hand tool.

As a result, since there is no movement of an operator to a workplace in which a large press machine is installed, the production efficiency can be further improved.

At the same time, since an assembly operation can be performed in a workspace as small as a desk top, the assembly efficiency can be significantly improved.

### BRIEF DESCRIPTION OF DRAWINGS

FIG. 1 is a perspective view illustrating an example of a solenoid according to the present invention.

FIG. 2 is an exploded perspective view of the solenoid illustrated in FIG. 1.

FIG. 3 is a vertical cross-sectional view of the solenoid illustrated in FIG. 1.

FIG. 4 is a partial cutaway cross-sectional view of an iron core configuring the solenoid illustrated in FIG. 1.

FIG. 5 is an exploded perspective view illustrating another example of a solenoid according to the present invention.

FIG. 6 is a vertical cross-sectional view of the solenoid illustrated in FIG. 5.

FIG. 7 is a partial cutaway cross-sectional view of an iron core configuring the solenoid illustrated in FIG. 5.

FIG. 8 is a vertical cross-sectional view illustrating a modified example of the solenoid illustrated in FIG. 5.

FIG. 9 is a perspective view illustrating a screw member configuring the solenoid illustrated in FIG. 8.

### DESCRIPTION OF EMBODIMENTS

A solenoid according to the present invention and a method for manufacturing the solenoid will be described in detail below with reference to the accompanying drawings.

Note that the present invention is not limited only to examples disclosed herein, and various modifications can be made thereto without changing the gist of the present invention.

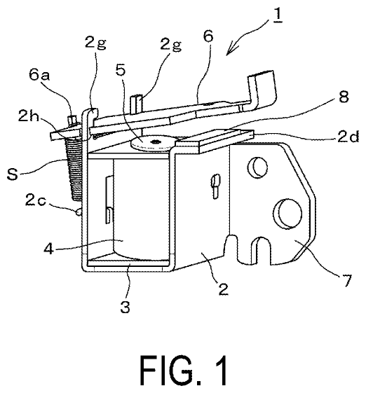

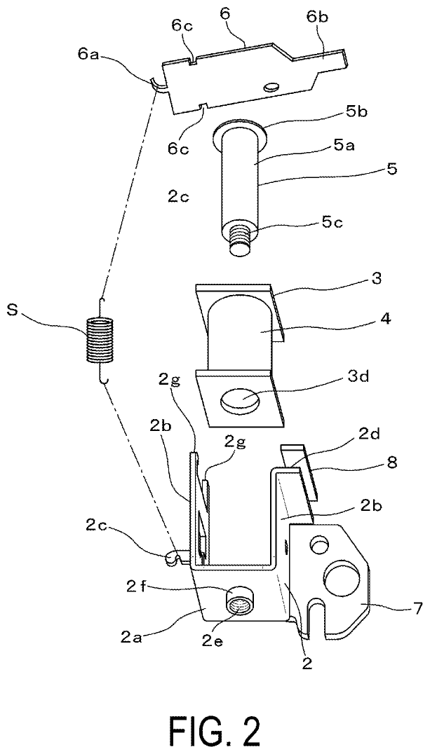

As illustrated in FIGS. 1 and 2, a flapper-type solenoid (hereinafter referred to as a “solenoid”) 1 according to the present invention includes a yoke 2 having a U-shaped cross section, a bobbin 3 installed inside a central portion of the yoke 2, an electromagnetic coil 4 wound around the bobbin 3, a fixed iron core 5 disposed inside the bobbin 4, and a flapper (a movable plate) 6 attached to the yoke 2 to be able to swing freely.

Note that in FIG. 1, the reference sign 7 denotes an attaching member configured to attach the yoke 2 to a predetermined apparatus or device such as a copying machine.

As illustrated in FIG. 2, the yoke 2 is formed as a body having a U-shaped cross section, which is formed by a base portion 2a configuring a bottom surface of the yoke 2 and a pair of raised portions 2b and 2b provided at both ends of the base portion 2a to be parallel to each other.

Note that in FIG. 1, end faces of the raised portions 2b and 2b are each configured to be flush with a flange portion 5b of the fixed iron core 5 in a state in which the fixed iron core 5 is attached.

As illustrated in FIGS. 1 to 3, the bobbin 3 includes a cylindrical portion 3a and a pair of circular plate portions 3b and 3c disposed on each end of the cylindrical portion 3a to face each other. Further, an insertion hole 3d having an inner diameter approximately equal to the outer diameter of the fixed iron core 5 is formed to penetrate through a center portion of the bobbin 3 along the axial direction.

Furthermore, an electromagnetic coil 4 that is formed of a plurality of conducting wires is wound around an outer circumferential portion of the cylindrical portion 3a.

The fixed iron core 5 is formed from iron or the like, and includes, as a main body thereof, a cylindrical core portion 5a having an outer diameter approximately equal to the inner diameter of the bobbin 3.

The greatest advantage of the solenoid 1 of the present invention is that the fixed iron core 5 is attached to the yoke 2, more specifically, to the base portion 2a of the yoke 2 by threaded fitting.

As a first embodiment, as illustrated in FIGS. 2 to 4, the fixed iron core 5 is configured by the cylindrical core portion 5a having the outer diameter approximately equal to the inner diameter of the insertion hole 3d of the bobbin 3, the disk-shaped flange portion 5b integrally provided on a top portion of the core portion 5a, and an external thread portion 5c formed protruding from a center portion of a bottom portion of the core portion 5a.

This external thread portion 5c is formed by forming a diameter-reduced portion protruding from the bottom portion of the core portion 5a, and forming a plurality of thread grooves 5d in an outer circumferential surface of the diameter-reduced portion along the circumferential direction, thereby forming a plurality of threads 5e therein.

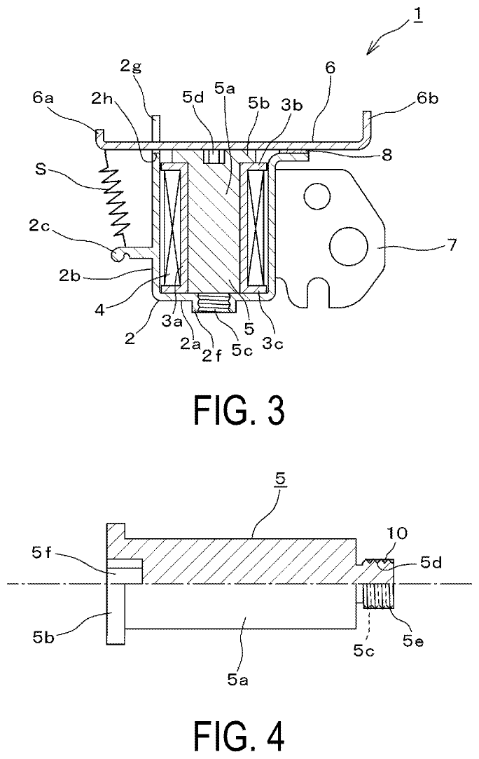

Note that, as illustrated in FIGS. 3 and 4, a hexagonal hole 5f of a required size is formed in a center portion of the flange portion 5b of the fixed iron core 5 such that attachment of the fixed iron core 5 can be easily performed using a hand tool. However, the shape of the hole may be selected according to the form of the hand tool, and may be a cross hole or the like other than the hexagonal hole.

Meanwhile, as illustrated in FIG. 2, an internal thread portion 2e that screws together with the external thread portion 5c is formed in a central portion of the base portion 2a of the yoke 2.

This internal thread portion 2e is constituted by a through hole configured to insert and hold the external thread portion 5c, and an internal thread having a reverse thread structure to that of the external thread part 5c is formed in an inner circumferential surface of the internal thread portion 2e.

Note that an annular portion 2f of a required height is formed protruding from an opening peripheral edge portion on the outer surface side of the through hole.

According to such a configuration, the external thread portion 5c of the fixed iron core 5 is attached to the yoke 2 by making threaded fitting with the internal thread portion (the through hole) 2e formed in the base portion 2a of the yoke 2.

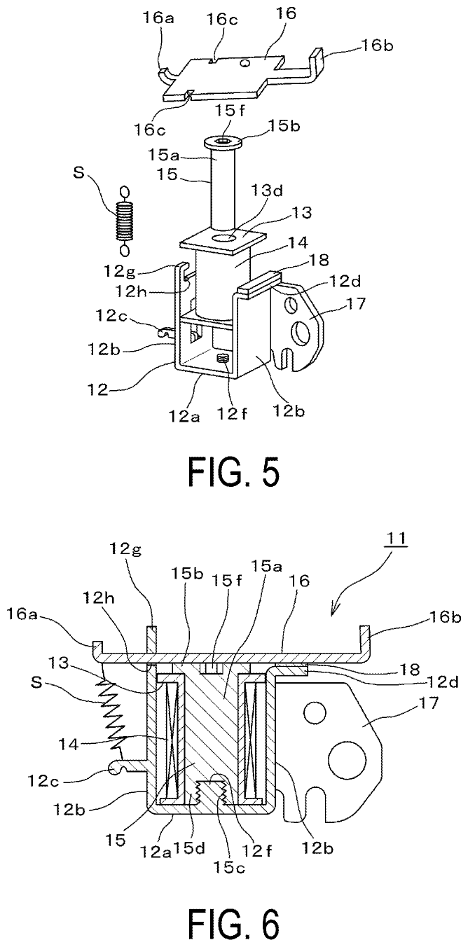

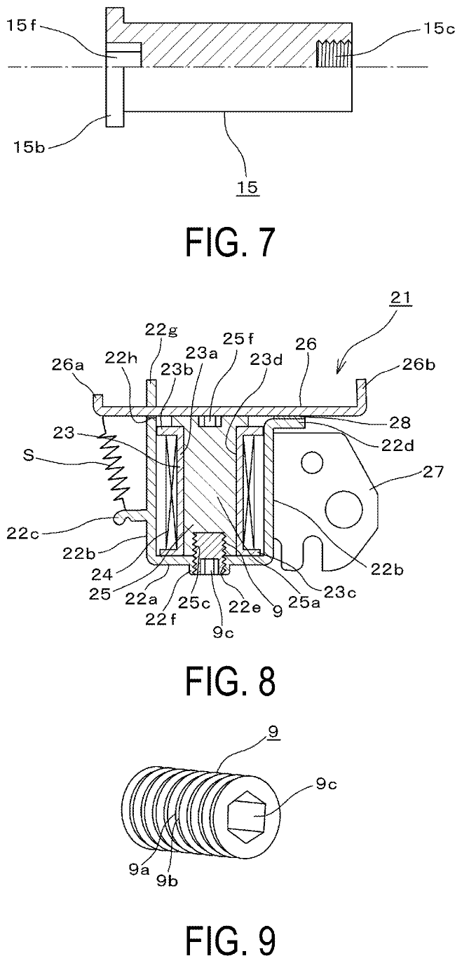

Furthermore, as a second embodiment, in a solenoid 11, as illustrated in FIGS. 5 to 7, a fixed iron core 15 has the same configuration as the fixed iron core 5 except that an internal thread portion 15c, which is constituted by a screw hole of a required depth including an internal thread in an inner circumferential surface thereof, is formed in a center portion of a bottom portion of a core portion 15a, instead of an external thread portion.

Meanwhile, as illustrated in FIGS. 5 and 6, an external thread portion 12f that screws together with the internal thread portion 15c is formed in a center portion of an inner surface of a base portion 12a of a yoke 12 to protrude toward the inside.

According to such a configuration, the external thread portion 12f formed in the base portion 12a of the yoke 12 can be attached to the yoke 12 by threaded fitting with the internal thread portion 15c of the fixed iron core 15.

According to such a configuration, it is not necessary to provide a protruding portion on a fixed iron core as an external thread portion.

A third embodiment illustrates a modified example of the second embodiment in which a yoke and a fixed iron core are integrally coupled by a rod-like external thread member.

Specifically, in a solenoid 21 illustrated in FIG. 8, a fixed iron core 25 and a yoke 22 are the same as the fixed iron core 15 and the yoke 2 respectively, but an internal thread portion 25c of the fixed iron core 25 and a through hole 22e of the yoke 22, on an inner circumferential surface of which the same internal thread as the internal thread portion 25c is formed, are communicated with each other and configured to form an internal thread portion.

Meanwhile, as illustrated in FIG. 9, a screw member 9 includes an external thread that is formed extending from a tip end toward a base end portion of an outer circumferential surface of the screw member 9 to screw together with the internal thread portion 25c of the fixed iron core 25 and the through hole (the internal thread portion) 22e formed in the base portion 22a of the yoke 22.

Note that, as illustrated in FIG. 9, a hexagonal hole 9c of a required size is also formed in an end portion of the screw member 9 such that attachment of the screw member 9 can be easily performed using a hand tool.

Thus, the fixed iron core 25 can be attached to the yoke 22 by inserting the screw member 9 into the through hole 22e from the outside thereof such that the tip of the screw member 9 penetrates through the through hole 22e, and by causing a protruding portion formed as a result of the insertion of the screw member 9 to screw together with the internal thread portion 25c of the fixed iron core 25.

Note that in the above-described Examples, three or more of the threads are formed in the external thread portion, and thread grooves corresponding to the threads are formed in the internal thread portion.

Thus, the external thread portion firmly screws together with the internal thread portion.

In the present invention, an adhesive layer of a required thickness is preferably formed on a surface of the thread grooves of at least one of the external thread portion or the internal thread portion provided on the fixed iron core or on the bottom surface of the yoke.

In FIG. 4, an adhesive layer 10 of the required thickness is formed on a surface of the thread grooves 5d of the external thread portion 5c of the fixed iron core 5.

Such a configuration allows the fixed iron core to be extremely firmly fixed to the yoke.

Note that the thickness of the adhesive layer is preferably set to a thickness that does not make it difficult to screw the external thread portion into the internal thread portion.

An adhesive configuring the adhesive layer is not particularly limited as long as the adhesive has adhesive properties.

Examples of the adhesive include mixtures or copolymers containing one type or two or more types of resin selected from a silicon-based resin, a polyimide-based resin, a polysulfone-based resin, a polyether sulfone-based resin, and a polyphenylsulfide-based resin, and one type or two or more types of resin selected from a polyester-based resin, an epoxy-based resin, a urethane-based resin, a melamine-based resin, an acrylic-based resin, a urea-based resin, and a polyamide-based resin.

From the perspective of ease of handling, as the adhesive, a dry adhesive is preferably selected that has no viscosity or extremely low viscosity and that adheres when a predetermined pressure is applied thereto.

More preferably, an adhesive containing an acrylic resin-based adhesive and/or an epoxy resin-based adhesive as a main component is selected.

Furthermore, in this example, the adhesive layer 10 is configured by a component in which an adhesive containing an acrylic resin-based adhesive or an epoxy resin-based adhesive as a main component is encapsulated in a microcapsule, and, in the present invention, the adhesive can be used in a form of being encapsulated in the microcapsule.

According to such a configuration, the microcapsule is broken by a pressure generated when the external thread portion is screwed into the internal thread portion, and the adhesive is released. As a result, an adhesive effect is deployed, so handling of the adhesive is extremely easy.

Note that a publicly known method can be used as a method for manufacturing the microcapsule in which the adhesive is encapsulated as an essential component.

Note that a method for forming the adhesive layer is not particularly limited as long as the method is capable of forming a layer that allows the external thread portion and the internal thread portion to be adhered and fixed to each other in a state of being screwed together.

For example, when an adhesive such as a rubber-based or synthetic resin-based adhesive, which does not exhibit adhesiveness in a dry state, is applied to one of the external thread portion and the internal thread portion and dried to form a layer, and on the other one of the external thread portion and the internal thread portion, a layer is formed that is configured by microcapsules each containing a plasticizer corresponding to the adhesive, the microcapsules are broken by the pressure generated when the external thread portion is screwed into the internal thread portion, and the plasticizer is released and comes into contact with the adhesive. As a result, the adhesive effect is deployed.

Furthermore, when, on one of the external thread portion and the internal thread portion, a layer is formed that is configured by microcapsules each encapsulating an adhesive agent or an adhesive (an epoxy resin-based adhesive, for example), and on the other one of the external thread portion or the internal thread portion, a layer is formed that is configured by microcapsules each containing a curing agent (an isocyanate, for example) corresponding to the adhesive agent or the adhesive, the microcapsules are broken by the pressure generated when the external thread portion is screwed into the internal thread portion, and the adhesive agent or the adhesive and the curing agent are released and come into contact with each other. As a result, the adhesive effect is deployed.

The intended effect can also be achieved with these configurations, so these configurations may also be employed.

In the present invention, it is sufficient that the flapper 6 is attached to the yoke 2 to be able to swing freely, and the configuration thereof is not particularly limited.

Note that in FIG. 1, the reference sign 6b denotes a locking piece formed by folding a tip end portion of the flapper 6 upward in order to engage the yoke 2 with a cam (not illustrated) of another apparatus or device.

In this example, as illustrated in FIG. 1, in the yoke 2, a pair of vertical flanges 2g and 2g are formed protruding from an upper surface of one of the raised portions 2b that face each other, and a flapper locking portion 2h, which is L-shaped in a side view, is formed by cutting a rectangular notch in a center portion, in the longitudinal direction, of an inner side surface of one of the vertical flanges 2g.

Meanwhile, as illustrated in FIG. 2, concave engaging portions 6c and 6c for respectively engaging with the pair of vertical flanges 2g and 2g are formed in edge portions of the flapper 6 near the base end side thereof, the edge portions facing each other in the longitudinal direction.

Furthermore, at a center portion of the outer surface of one of the raised portions 2b of the yoke 2, a protrusion 2c is provided protruding slightly downwardly, and one end of a spring member S that constantly urges the flapper 6 in a direction causing the flapper 6 to move away from the yoke 2 is engaged with the protrusion 2c.

Meanwhile, as illustrated in FIGS. 1 and 2, a protruding portion 6a, which is L-shaped in a side view and with which the other end of the spring member S is engaged, is integrally provided attaching to a base end portion of the flapper 6.

Therefore, after introducing the flapper 6 by inserting the flapper 6 between the pair of vertical flanges 2g and 2g of the yoke 2 and engaging the engaging portions 6c and 6c respectively with a base portion of the flapper locking portion 2h and a base portion of the other raised portion 2b, by attaching the spring member S between the protruding portion 6a of the flapper 6 and the protrusion 2c of the yoke 2, the flapper 6 can be attached to the yoke 2 to be able to swing freely.

Note that in this example, the pair of vertical flanges 2g and 2g that pivotally support the base end portion of the flapper 6 are formed protruding from the upper surface portion of the other raised portion 2b, while a sound attenuating member mounting portion 2d is provided in the other raised portion 2b to extend from the upper end thereof outwardly in the horizontal direction. By placing a sound attenuating member 8 on the sound attenuating member mounting portion 2d, an impact sound of the flapper 6, which may be generated as a result of the flapper 6 being attracted by the fixed iron core 5 and being moved, can be attenuated.

In the solenoid having such a configuration, first, the electromagnetic coil is wound around the bobbin, and then, the bobbin is installed inside the yoke.

Then, the fixed iron core is inserted into the bobbin, and, using the through hole (the internal thread portion) or the protruding portion (the external thread portion) formed on the bottom surface of the yoke, the fixed iron core is fitted with the yoke by the threaded fitting.

Further, the flapper is introduced by inserting between the pair of vertical flanges of the yoke to be pivotally supported thereby, and the solenoid is assembled.

### INDUSTRIAL APPLICABILITY

In a flapper-type solenoid according to the present invention, since a fixed iron core is attached to a bottom surface of a yoke by threaded fitting, a crimping operation is not required, and the fixed iron core can be firmly fixed to the yoke using a small, inexpensive general-purpose hand tool. Thus, the solenoid can be used in a wide range of fields.

### REFERENCE SIGNS LIST

1, 11, 21 Solenoid
2, 12, 22 Yoke
2a, 12a, 22a Base portion
2b, 12b, 22b Raised portion
2c, 12c, 22c Protrusion
2d, 12d, 22d Sound attenuating member mounting portion
2e, 22e Through hole
2f, 22f Annular portion
2g, 12g, 22g Vertical flange
2h, 12h, 22h Flapper locking portion
3, 13, 23 Bobbin
3a, 13a, 23a Cylindrical portion
3b, 13b, 23b Circular plate portion (upper side)
3c, 13c, 23c Circular plate portion (lower side)
3d, 13d, 23d Insertion hole
4, 14, 24 Electromagnetic coil
5, 15, 25 Fixed iron core
5a, 15a, 25a Core portion
5b, 15b, 25b Flange portion
5c External thread portion
5d Thread groove
5e Thread
5f, 15f, 25f Hexagonal hole
6, 16, 26 Flapper
6a, 16a, 26a Protruding portion
6b, 16b, 26b Locking piece
6c, 16c, 26c Engaging portion
7, 17, 27 Attaching member
8, 18, 28 Sound attenuating member
9 Screw member
9a Thread groove
9b Thread
9c Hexagonal hole
10 Adhesive layer
12f External thread portion
15c, 25c Internal thread portion
S Spring member

1-11. (canceled)

12. A solenoid comprising:
a yoke having a U-shaped cross section;
a bobbin having an electromagnetic coil disposed inside the yoke;
a fixed iron core disposed inside the bobbin; and
a flapper attached to the yoke to be able to swing freely, wherein
the fixed iron core and a bottom surface of the yoke are integrally coupled by threaded fitting,
a thread groove of at least one of an external thread and an internal threaded fitted together by the threaded fitting includes, on a surface thereof, an adhesive layer configured by a microcapsule encapsulating an adhesive component, and
a hole of a required size is formed in a center portion of a top portion of the fixed iron core.

13. The solenoid according to claim 12,
wherein the hole is one of a hexagonal hole or a cross hole.

14. The solenoid according to claim 12,
wherein the adhesive layer includes at least one of an epoxy resin-based adhesive and an acrylic resin-based adhesive as a main component thereof.

15. The solenoid according to claim 12,
wherein the fixed iron core has an external thread portion on a bottom portion thereof, and
the bottom surface of the yoke has an internal thread portion that is constituted by a through hole having an inner circumferential surface formed with an internal thread, such that the internal thread portion screws together with the external thread portion.

16. The solenoid according to claim 12,
wherein the bottom surface of the yoke has an external thread portion that is formed protruding toward the inside, and
the fixed iron core has, on a tip end surface thereof, an internal thread portion that is constituted by a screw hole of a required depth having an inner circumferential surface formed with an internal thread, such that the internal thread portion screws together with the external thread portion.

17. The solenoid according to claim 12,
wherein an internal thread portion is formed by communicating a through hole forming in the bottom surface of the yoke and having an internal thread on an inner circumferential surface thereof, and a screw hole of a required depth formed at a tip end surface of the fixed iron core, and having an internal thread on an inner circumferential surface thereof, with each other, and
the bottom surface of the yoke and the fixed iron core are integrally coupled by a rod-like external thread member including an external thread that is formed extending from a tip end toward a base end portion of an outer circumferential surface of the thread member such that the thread member screws together with the internal thread portion.

18. The solenoid according to claim 15,
wherein the external thread portion includes no less than three threads.

19. The solenoid according to claim 12,
wherein the flapper is pivotally supported by a vertical flange formed on one of raised portions of the yoke, and the flapper is configured to be able to swing freely by a spring member being attached between the yoke and the flapper.

20. The solenoid according to claim 15,
wherein the through hole includes an annular portion formed protruding at a required height around an opening peripheral edge portion on the outer surface side of the through hole.

21. A method for manufacturing a flapper-type solenoid, comprising:
inserting a fixed iron core, including a hole of a required size being formed in a center portion of a top portion of the fixed iron core, into a bobbin, after installing the bobbin including an electromagnetic coil inside a yoke having a U-shaped cross section; and
causing the fixed iron core threaded fitting with a bottom surface of the yoke, wherein
a thread groove of at least one of an external thread and an internal thread fitted together by the threaded fitting includes, on a surface thereof, an adhesive layer configured by a microcapsule encapsulating an adhesive component.

22. The solenoid according to claim 16,
wherein the external thread portion includes no less than three threads.

23. The solenoid according to claim 17,
wherein the external thread portion includes no less than three threads.

24. The solenoid according to claim 13,
wherein the flapper is pivotally supported by a vertical flange formed on one of raised portions of the yoke, and the flapper is configured to be able to swing freely by a spring member being attached between the yoke and the flapper.

25. The solenoid according to claim 14,
wherein the flapper is pivotally supported by a vertical flange formed on one of raised portions of the yoke, and the flapper is configured to be able to swine freely by a spring member being attached between the yoke and the flapper.

26. The solenoid according to claim 15,
wherein the flapper is pivotally supported by a vertical flange formed on one of raised portions of the yoke, and the flapper is configured to be able to swing freely by a spring member being attached between the yoke and the flapper.

27. The solenoid according to claim 16,
wherein the flapper is pivotally supported by a vertical flange formed on one of raised portions of the yoke, and the flapper is configured to be able to swing freely by a spring member being attached between the yoke and the flapper.

28. The solenoid according to claim 17,
wherein the flapper is pivotally supported by a vertical flange formed on one of raised portions of the yoke, and the flapper is configured to be able to swing freely by a spring member being attached between the yoke and the flapper.

29. The solenoid according to claim 18,
wherein the flapper is pivotally supported by a vertical flange formed on one of raised portions of the yoke, and the flapper is configured to be able to swing freely by a spring member being attached between the yoke and the flapper.

30. The solenoid according to claim 17,
wherein the through hole includes an annular portion formed protruding at a required height around an opening peripheral edge portion on the outer surface side of the through hole.
